(19) United States
(12) Patent Application Publication
(10) Pub. No.: US 2012/0124275 A1
(43) Pub. Date: May 17, 2012

(54) MEMORY SYSTEM AND DATA STORAGE METHOD

(75) Inventor: Daisuke Hashimoto, Kanagawa (JP)

(73) Assignee: Kabushiki Kaisha Toshiba, Tokyo (JP)

(21) Appl. No.: 13/069,963

(22) Filed: Mar. 23, 2011

(30) Foreign Application Priority Data
Nov. 15, 2010 (JP) 2010-255411

(51) Int. Cl. G06F 12/00

(52) U.S. Cl. 711/103; 711/E12.008

(57) ABSTRACT

According to one embodiment, a memory system includes a volatile memory, a first non-volatile memory connected to the volatile memory, a second non-volatile memory connected to the volatile semiconductor memory, and a memory controller. The memory controller is configured to store latest management information to the volatile memory, to store previous management information to the first non-volatile memory, and to store difference data between the latest management information and the previous management information to the second non-volatile memory.

### CROSS-REFERENCE TO RELATED APPLICATIONS

This application is based upon and claims the benefit of priority from the prior Japanese Patent Application. No. 2010-255411, filed on Nov. 15, 2010; the entire contents of which are incorporated herein by reference.

### FIELD

Embodiments generally relate to a memory system and a data storage method.

### BACKGROUND

Recently, solid state drives (SSD) have been variously developed as a memory drive mounted on a computer system. Since the SSD is mounted with a non-volatile flash memory, the SSD has a featured in that it is high speed as well as light in weight in comparison with a hard disc.

### BRIEF DESCRIPTION OF THE DRAWINGS

FIG. 1 is a block diagram illustrating the configuration of a memory system according to a first embodiment;

FIG. 2 is a view illustrating a management table as to management information according to the first embodiment;

FIG. 3 is a view illustrating a management information difference table that illustrates the management information according to the first embodiment;

FIG. 4 is a view illustrating a data type of the information stored in a second non-volatile memory according to the first embodiment;

FIG. 5A and FIG. 5B are views illustrating an overwrite method of management information difference data in the second non-volatile memory according to the first embodiment;

FIG. 6 is a view illustrating an erase method of the management information difference data in the second non-volatile memory according to the first embodiment;

FIG. 7 is a view illustrating a rewrite method of the management information difference data in the second non-volatile memory according to the first embodiment;

FIG. 8 is a flowchart illustrating a read method of the management information difference data in the second non-volatile memory according to the first embodiment;

FIG. 9A and FIG. 9B are views illustrating the read method of the management information difference data in the second non-volatile memory according to the first embodiment; and

FIG. 10 is a block diagram illustrating the configuration of a memory system according to a second embodiment.

### DETAILED DESCRIPTION

Since the number of times of rewrite of the non-volatile flash memory, in particular, the number of times of rewrite of a NAND type flash memory mounted on the SSD is restricted from a view point of reliability, it must be avoided to frequently access data in a specific region.

Accordingly, a memory drive is mounted with a high speed volatile random access memory such as a dynamic random access memory (DRAM) and the like, and data such as management information and the like which is frequently accessed is stored on the DRAM. The reliability of the memory drive is secured by suppressing the access to the non-volatile flash memory as described above.

When an abnormal power shut-off, in which a power supply is shut off without preadvice occurs at the time the memory drive is mounted with the volatile memory such as the DRAM, since the data stored in the volatile memory cannot be evacuated to a non-volatile memory, there is a possibility that latest management information and the like are lost. As a result, since the management information stored on the volatile memory does not match with the data or the management information of the data on the non-volatile memory as a main memory region, the data may not be recovered.

Therefore, even if the abnormal power shut-off occurs, it is desired to recover data to a data state before the abnormal power shut-off occurs.

In general, according to one embodiment, a memory system includes a volatile memory, a first non-volatile memory connected to the volatile memory, a second non-volatile memory connected to the volatile memory, and a memory controller. The memory controller is configured to store latest management information to the volatile memory, to store previous management information to the first non-volatile memory, and to store difference data between the latest management information and the previous management information to the second non-volatile memory.

A memory system and a data storage method according to the embodiments will be explained below in detail referring to the attached drawings. Note that the invention is by no means limited by the embodiments.

### First Embodiment

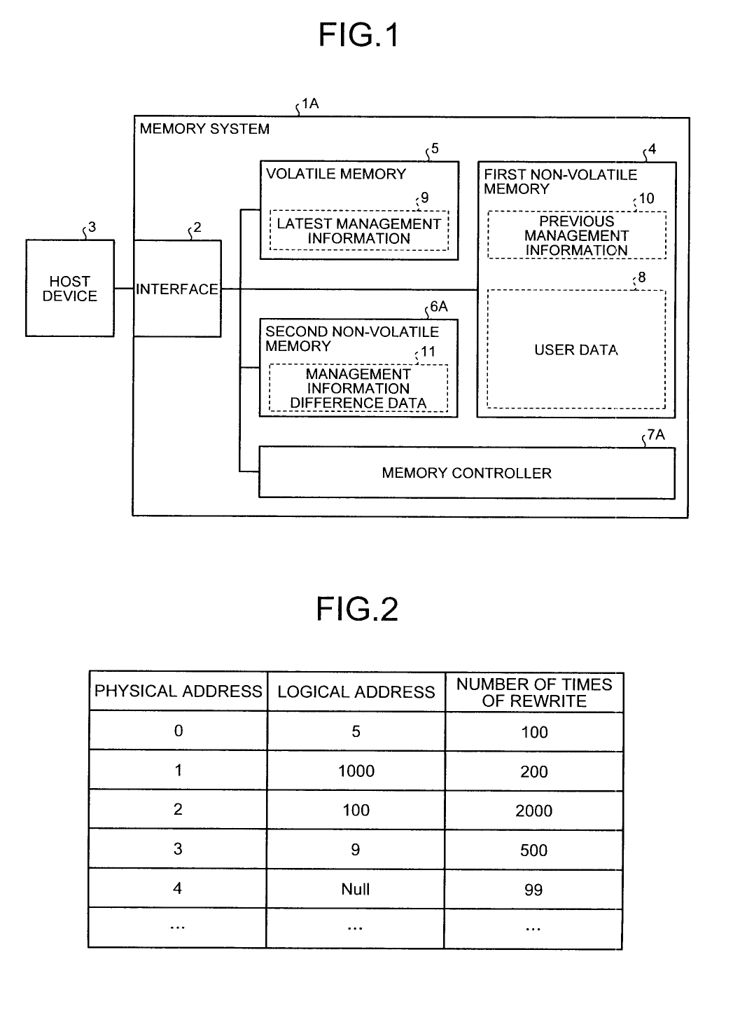

FIG. 1 is a block diagram illustrating the configuration of a memory system 1A according to a first embodiment. The memory system 1A according to the first embodiment is a SSD that is connected to a host device 3 such as a computer or a CPU core and the like via an interface 2 such as a SATA interface and the like and functions as an external memory of the host device 3. The memory system 1A includes the interface 2, a NAND type flash memory as a first non-volatile memory 4, a volatile memory 5, a non-volatile memory, which has a relatively small capacity and is a high speed, as a second non-volatile memory 6A, and a memory controller 7A. Used as the volatile memory 5 is, for example, a dynamic random access memory (DRAM) or a static random access memory (SRAM). The interface 2 determines a protocol for transmitting and receiving a signal in a communication between the memory system 1A and the host device 3 such as the computer and the like, and a serial interface, for example, a serial advanced technology attachment (SATA), a serial attached SCSI (SAS), Universal Serial Bus (USB), and the like are exemplified as the interface 2.

The first non-volatile memory 4 is a main storage memory of the host device 3 such as the computer and records user data 8 of the host device 3, management information and the like. A NAND type flash memory, for example, is used to the first non-volatile memory 4. The management information includes a management table for causing a physical address on a NAND type flash memory as illustrated in FIG. 2 to correspond to a logical address designated by the host device 3, for example, Logical Block Address (LBA). The management table is aligned in, for example, a block size of the NAND type flash memory, a page size of the NAND type flash memory, and a multiple number of minimum logical address unit.

FIG. 2 illustrates a table that illustrates a correspondence between a physical address and a logical address and the number of times of rewrite to respective physical addresses. The management information on the NAND type flash memory is developed on the volatile memory 5 when the memory system 1A starts. When the memory controller 7A operates normally, the memory controller 7A writes data to the first non-volatile memory 4 and reads data from the first non-volatile memory 4 based on the management information developed on the volatile memory 5. Further, although the management information stored in the volatile memory 5 is updated as the data is written, the management information stored in the first non-volatile memory 4 is not necessarily updated to latest management information. As a result, the first non-volatile memory 4 may store non-latest management information (hereinafter, called previous management information).

The volatile memory 5 is a cash memory in which data is temporarily stored when the memory controller 7A performs writing or reading to the first non-volatile memory 4 and has a role for storing management information in a latest state (hereinafter, called latest management information). As the data is written to the first non-volatile memory 4, the memory controller 7A updates the management information stored in the volatile memory 5. Note that the volatile memory 5 may be a memory for storing the latest user data 8 in the host device 3.

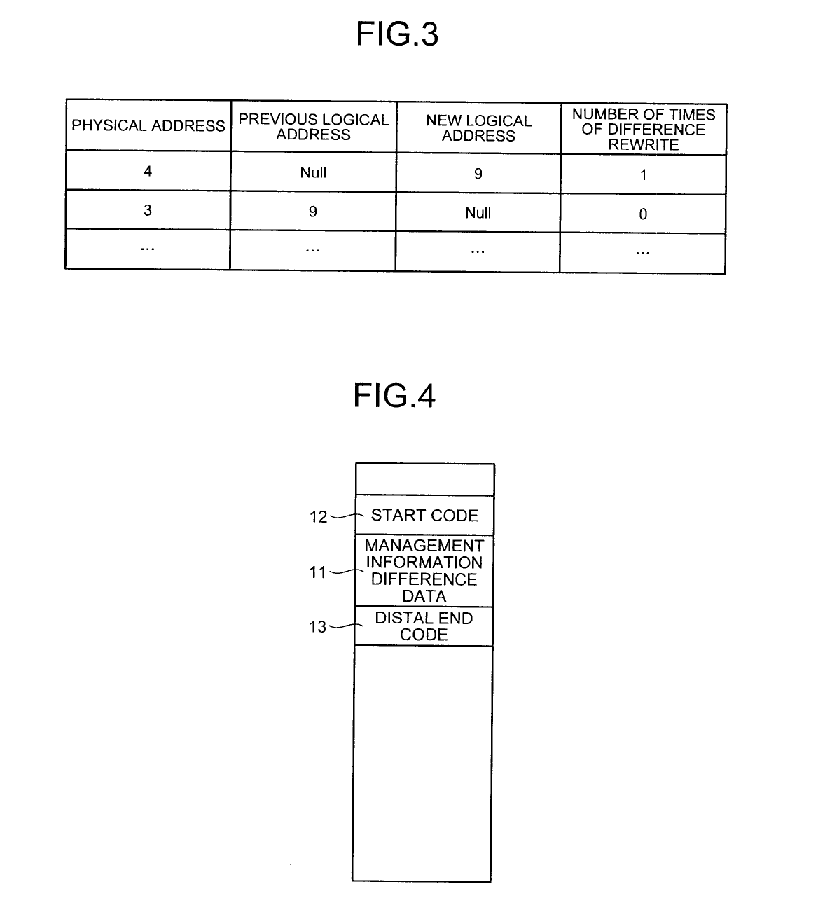

When the management information is updated on the volatile memory 5, the second non-volatile memory 6A stores difference data between the update data of the management information, that is, the latest management information 9 stored in the volatile memory 5 and the previous management information 10 (hereinafter, called the management information difference data 11). When the management information stored in the volatile memory 5 is updated as data is written to the first non-volatile memory 4, the memory controller 7A causes the second non-volatile memory 6A to store the management information difference data 11. As illustrated in a management information difference table in FIG. 3, the management information difference data 11 includes a table illustrating the physical address, a previous logical address, a new logical address, and the number of times of rewrite to the physical address on the NAND type flash memory. The previous logical address means a logical address stored in the volatile memory 5 before the management information is updated, and the new logical address means a logical address after the management information is updated.

The memory capacity of the second non-volatile memory 6A is smaller than, for example, the first non-volatile memory 4. Otherwise, the memory capacity of the second non-volatile memory 6A is smaller than the volatile memory 5. Further, the second non-volatile memory 6A has a latency smaller than, for example, the first non-volatile memory 4 and further can make a random access. Further, the rewritable number of times of the second non-volatile memory 6A is larger than, for example, the first non-volatile memory 4. Further, the reliability of the second non-volatile memory 6A is higher than, for example, the first non-volatile memory 4.

An abnormal power supply shut-off can be coped with using the memory without damaging the processing speed and the reliability of the memory system 1A by the use of the memories. Used as the second non-volatile memory 6A is, for example, a ferroelectric random access memory (FeRAM) or a magnetoresistive random access memory (MRAM). In the memory system 1A according to the embodiment, the reliability of the memory system 1A is secured by that the management information difference data 11, which has a large number of times of update, is not stored in the NAND type flash memory used as the first non-volatile memory 4.

The memory controller 7A controls the data transmission/reception between the first non-volatile memory 4, the volatile memory 5, and the second non-volatile memory 6A and the host device 3 connected thereto via the interface 2. Further, the memory controller 7A controls the respective operations of the memory system 1A to be described later such as the update of the management information, the storage of the management information difference data, the recovery from the abnormal power supply shut-off.

An operation of the memory system 1A will be explained below referring to the drawings.

### (Storage Format of Management Information Difference Data)

FIG. 4 is a view illustrating a storage format of the management information difference data 11 on the second non-volatile memory 6A. The region of a valid management information difference data 11 can be identified by a start code 12 and an distal end code 13. The start code 12 and the distal end code 13 are configured to discriminate the pattern of the management information difference data 11 and the pattern of a non-written region. The start code 12 and the distal end code 13 can be identified by providing, for example, one redundant bit.

To prevent the concentration of writing of the management information difference data 11 to a specific address, the embodiment employs such a system that the address of the management information difference data 11 is not written to a specific fixed region, and the overall address space of the second non-volatile memory 6A is circulatingly used. In the system, when the management information difference data 11 is read, since the address space is sequentially read from its leading end up to the distal end code 13, a time is required for a search. However, since the management information difference data 11 is read only when the memory system 1A is restarted after the abnormal power supply shut-off occurs, the performance of the memory system 1A is not deteriorated by a slow reading speed.

### (Overwrite Method of Management Information Difference Data)

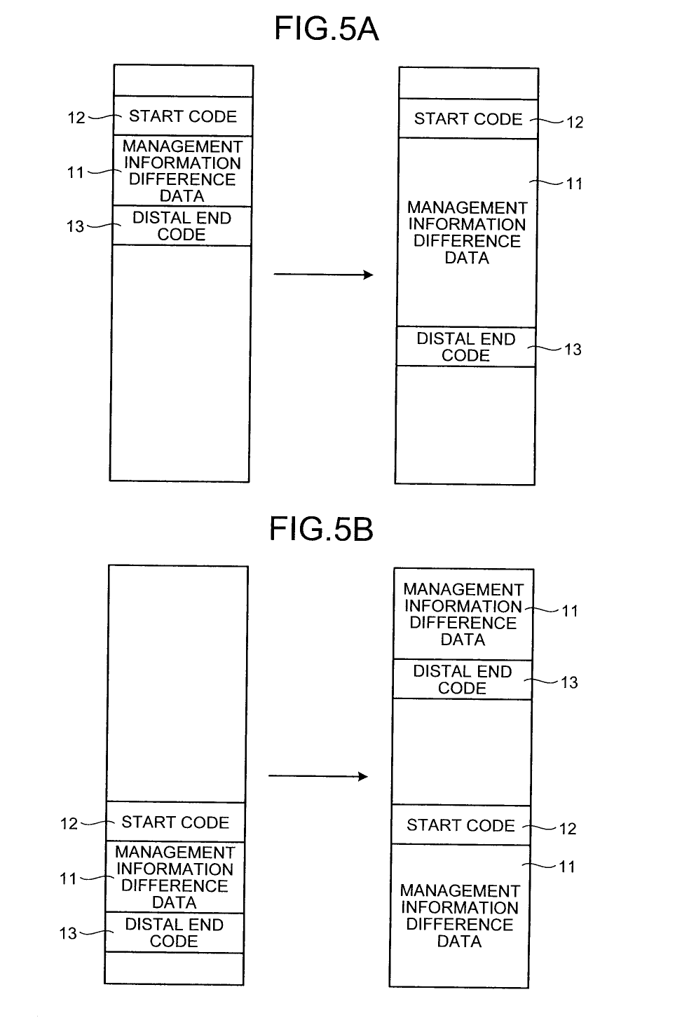

An overwrite method of the management information difference data 11 will be explained using FIG. 5A and FIG. 5B. FIG. 5A illustrates an address space in which the management information difference data 11 is written on the second non-volatile memory 6A. In the state, the management information difference data 11 to be overwritten is overwritten from the distal end code 13. Thereafter, after the management information difference data 11 is entirely written, the distal end code 13 is newly written to an address just behind the data. In the case, since the data to be added is only the management information difference data 11 and a new distal end code 13, overwriting can be performed to the second non-volatile memory 6A at high speed. Note that even in a state in which the management information difference data 11 is not written, data can be overwritten by the same method.

As illustrated in FIG. 5B, when the distal end of the management information difference data 11 exceeds the terminal end of an address at the time the management information difference data 11 is overwritten, excessive data is sequentially written from the leading end of the address space, and the distal end code 13 is written to the address just behind the data. In the case, the distal end code 13 is written to the address in front of the start code 12.

### (Erase Method of Management Information Difference Data)

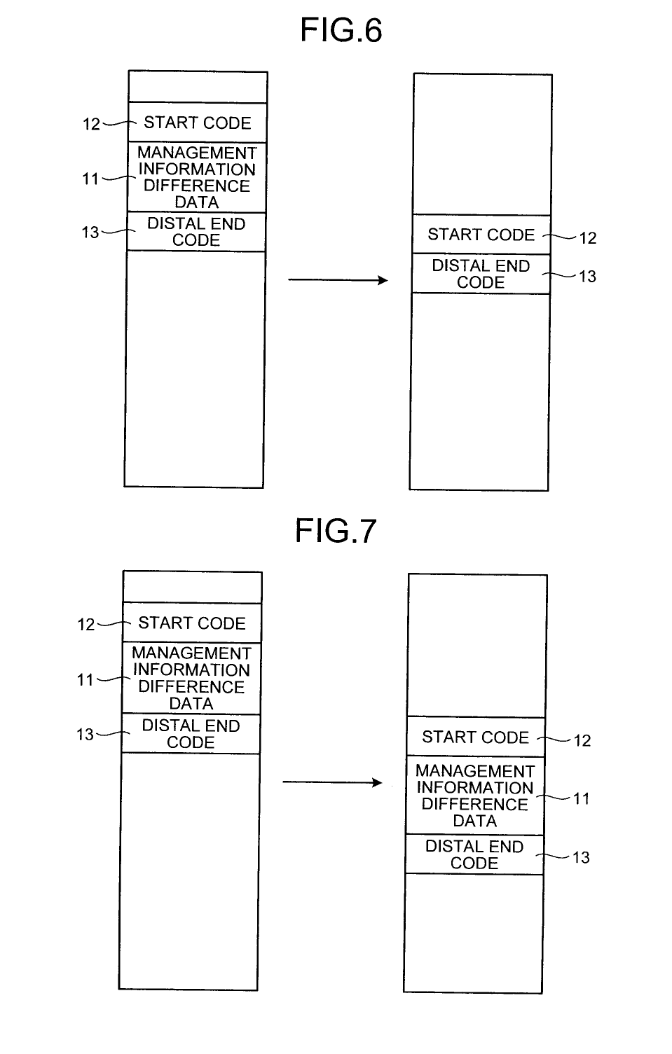

An erase method of the management information difference data 11 will be explained using FIG. 6. The erase method is used when, for example, the management information on the first non-volatile memory 4 is updated to the latest management information due to a normal power supply shut-off of the memory system 1A and the management information difference data 11 on the second non-volatile memory 6A becomes unnecessary. FIG. 6 illustrates an address space in which the management information difference data 11 is written on the second non-volatile memory 6A. In the state, invalid data, for example, data composed of only 0 is overwritten to the start code 12, the start code 12 is newly overwritten to the distal end code 13, and the distal end code 13 is written to the address just behind the new start code 12. In the state, the management information difference data 11 is not written between the start code 12 and the distal end code 13. With the operation, when the second non-volatile memory 6A is read, it is recognized that the management information difference data 11 does not exist. Since the erase method is performed by overwriting to the start code 12 and to the distal end code 13 and writing of the new distal end code 13, the erase method can erase the management information difference data at high speed.

### (Rewrite Method of Management Information Difference Data)

A rewrite method of the management information difference data 11 will be explained using FIG. 7. The update method is used when the management information on the first non-volatile memory 4 is updated to the latest management information due to the normal power supply shut-off of the memory system 1A and difference data is newly written in the state that the management information difference data 11 on the second non-volatile memory 6A is not erased. FIG. 7 illustrates the address space in which the management information difference data 11 is written on the second non-volatile memory 6A. In the state, invalid data, for example, data composed of only 0 is overwritten to the start code 12, the start code 12 is newly overwritten to the distal end code 13, the management information difference data 11 is written from the address just behind the start code 12, and thereafter the distal end code 13 is written to the distal end of the management information difference data 11. Since the rewrite method is performed by the overwriting to the start code 12 and the distal end code 13, the writing of the management information difference data 11, the new writing of the distal end code 13, the management information difference data 11 can be rewritten at high speed.

### (Read Method of Management Information Difference Data)

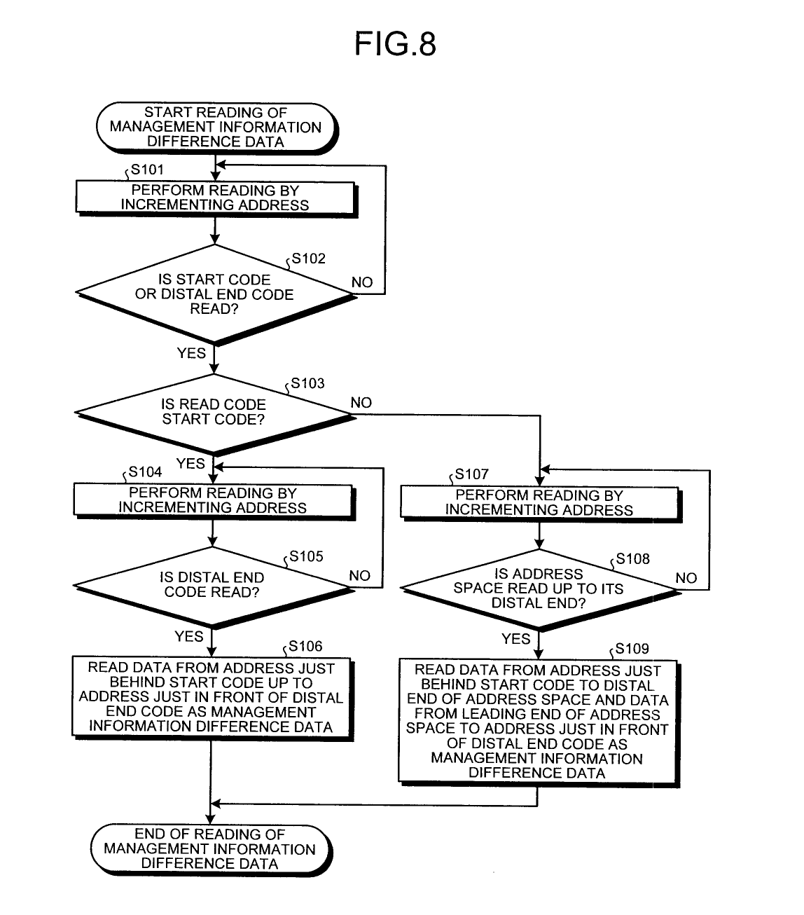

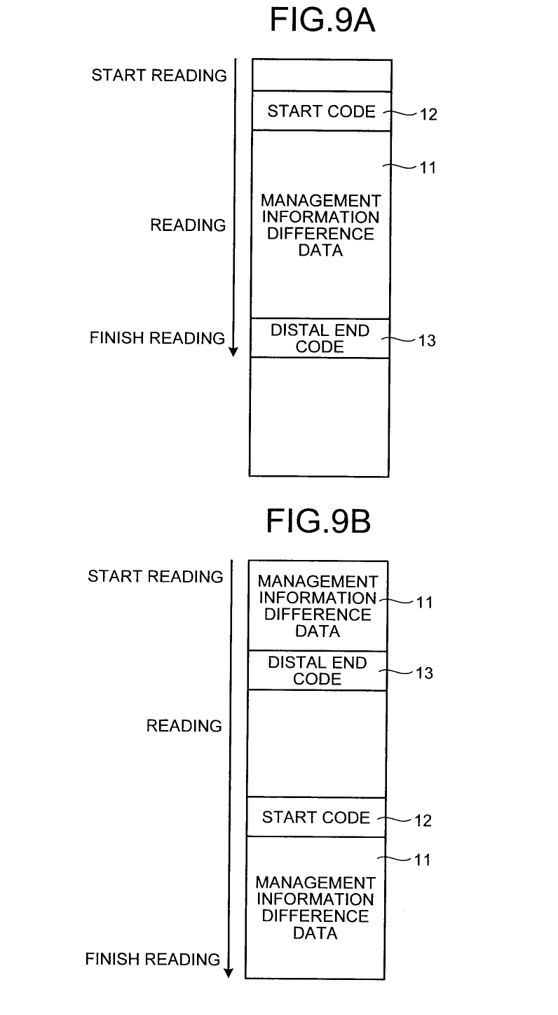

FIG. 8 illustrates a flowchart illustrating a read method of the management information difference data 11 in the second non-volatile memory according to the first embodiment, and FIG. 9A and FIG. 9B show address spaces when the start code 12 exists in front of the distal end code 13 and behind the distal end code 13. The read method of the management information difference data 11 will be explained below using FIG. 8 and FIGS. 9A and 9B.

First, the memory controller 7A increments an address from the leading end of the address space of the second non-volatile memory 6A and performs a read operation (S101). Thereafter, the memory controller 7A determines whether the read data is the start code 12 or the distal end code 13 (S102).

When the read data is not the start code 12 or the distal end code 13, the memory controller 7A increments an address again and performs the read operation (S101). In contrast, when the read data is the start code 12 or the distal end code 13, the memory controller 7A determines whether the read code is the start code 12 (S103).

When the read code is the start code 12, the memory controller 7A increments an address and performs the read operation (S104). Thereafter, the memory controller 7A determines whether or not the distal end code 13 is read (S105). When the distal end code 13 is not read, the memory controller 7A increments an address again and performs the read operation (S104). When the distal end code 13 is read, the memory controller 7A reads the data from the address just behind the start code 12 to the address just in front of the distal end code 13 as the management information difference data 11 (S106).

When the read code is not the start code 12, that is, when the read code is the distal end code 13, the memory controller 7A increments an address and performs the read operation (S107). Thereafter, the memory controller 7A determines whether or not the address space is read up to its distal end (S108). When the address space is not read up to its distal end, the memory controller 7A increments an address again and performs the read operation (S107).

When the address space is read up to its the distal end, the memory controller 7A reads the data from the address just behind the start code 12 up to the distal end of the address space and the data from the leading end of the address space up to the address just in front of the distal end code 13 as the management information difference data 11 (S109).

As illustrated in FIG. 9A, when the start code 12 exists in front of the distal end code 13, reading is started from the leading end of the address space and finished in the distal end code 13. At the time, the data from the address just behind the start code 12 to the address just in front of the distal end code 13 is read as the management information difference data 11.

As illustrated in FIG. 9B, when the start code 12 exits behind the distal end code 13, the reading is started from the leading end of the address space and finished in the distal end of the address space. At the time, the data from the address just behind the start code 12 to the distal end of the address space and the data from the leading end of the address space to the address just in front of the distal end code 13 are read as the management information difference data 11.

(When Memory Region of Second Non-Volatile Memory 6A is Entirely Filled with Data)

When the memory region of the second non-volatile memory 6A is entirely filled with the management information difference data 11, the following operation will be performed. First, the latest management information 9 on the volatile memory 5 is written to the first non-volatile memory 4, and the management information on the first non-volatile memory 4 is replaced with the latest management information. Thereafter, the management information difference data 11 on the second non-volatile memory 6A is erased. With the operation, the management information difference data 11 can secure the memory region of the second non-volatile memory 6A. Note that when the memory region of the second non-volatile memory 6A is entirely filled with the management information difference data 11, the management information difference data 11, which cannot be stored in the second non-volatile memory 6A, may be overwritten to the first non-volatile memory 4.

A case, in which the power supply is normally shut off and a case in which the power supply is abnormally shut off, will be explained below.

### (When Power Supply is Normally Shut Off)

An operation of the memory system 1A when the power supply is normally shut off will be explained. When the power supply is normally shut off, the latest management information 9 on the volatile memory 5 is written to the first non-volatile memory 4, and the management information on the first non-volatile memory 4 is replaced with the latest management information. Thereafter, the management information difference data 11 on the second non-volatile memory 6A is erased. With the operation, the memory region of the second non-volatile memory 6A can be prevented from being entirely filled with the management information difference data 11. When the memory system 1A is started next, the latest management information stored in the first non-volatile memory 4 is developed to the volatile memory 5.

Note that it is assumed a case in which, when the power supply is normally shut off, it may not be always necessary to write the latest management information 9 on the volatile memory 5 to the first non-volatile memory 4. This is, for example, a case in which the size of the management information difference data 11 is small and the memory region of the second non-volatile memory 6A has an allowance in capacity, a case in which, when the memory system 1A is started, a sufficient time is prescribed in specification to recover the latest management information by the management information difference data 11, and the like.

### (When Power Supply is Abnormally Shut Off)

A data recovery operation of the memory system 1A when the power supply is not normally shut off and is abnormally shut off will be explained. When the abnormal power supply shut-off occurs, since the data of the latest management information 9 on the volatile memory 5 is lost, when the memory system 1A is started next, the data of the management information is recovered.

First, the previous management information 10 on the first non-volatile memory 4 is read to the volatile memory 5. Thereafter, the previous management information 10 on the volatile memory 5 is recovered to the latest management information 9 based on the management information difference data 11 on the second non-volatile memory 6A.

Note that after operation, the updated latest management information 9 on the volatile memory 5 may be written to the first non-volatile memory 4. When the memory system 1A is restarted after the abnormal power supply shut-off, since a relatively long start time is allowed, the operation of the memory system 1A can be stabilized by writing the latest management information 9 to the first non-volatile memory 4 once. Further, the management information difference data 11 on the second non-volatile memory 6A may be erased thereafter. With the operation, the memory region of the second non-volatile memory 6A can be prevented from being entirely filled with the management information difference data 11.

As described above, according to the first embodiment, since the memory system 1A stores the management information difference data 11, a high speed non-volatile memory with a small capacity is used as the second non-volatile memory 6A. Since the second non-volatile memory 6A the difference data having a small data amount, the high speed non-volatile memory with the small capacity that is less expensive can be used to the second non-volatile memory 6A, and the memory system 1A can operate at high speed.

Further, according to the first embodiment, the second non-volatile memory 6A stores the management information difference data 11. Accordingly, even if the power supply is abnormally shut off, when the power supply is started next, the management information can be recovered to latest management information before the abnormal power supply shut-off occurs.

### Second Embodiment

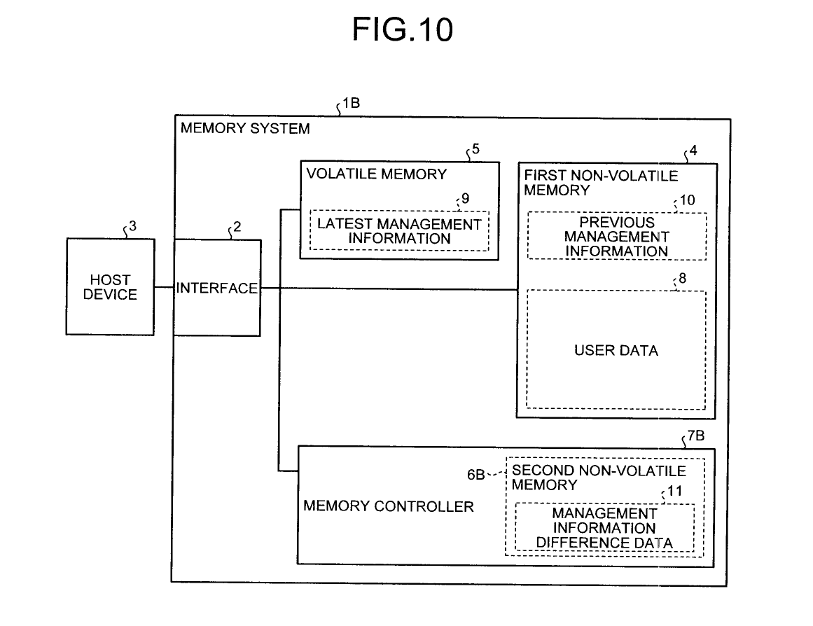

A memory system 1B according to a second embodiment will be explained using FIG. 10. As to the configuration of the second embodiment, the same sections as those of the memory system 1A of the first embodiment are denoted by the same reference numerals, and an detailed explanation of the same sections is omitted. The second embodiment is different from the first embodiment in that although, in the memory system 1A, the second non-volatile memory 6A is disposed independently of the memory controller 7A, in the memory system 1B, a second non-volatile memory 6B is mounted inside of a chip of a memory controller 7B as a built-in type memory. Note that since the memory controller 7B including the second non-volatile memory 6B has a function of a combination of the second non-volatile memory 6A and the memory controller 7A. For example, a high speed non-volatile memory such as FeRAM or MRAM and the like can be assembled to the chip of the memory controller 7B.

Also in the memory system 1B according to the second embodiment, the management information difference data 11 can be overwritten, erased, rewritten, and read by the same storage system as the memory system 1A according to the first embodiment by storing the management information difference data 11 in the second non-volatile memory 6B.

As described above, according to the second embodiment, in the memory system 1B, a high speed non-volatile memory with a small capacity is used as the second non-volatile memory 6B to store the management information difference data 11. Since the second non-volatile memory 6B is caused to store the difference data having a small data load, the high speed non-volatile memory that is less expensive can be used, and thus the memory system 1B can operated at higher speed than the memory system 1A.

Further, according to the second embodiment, the second non-volatile memory 6B stores the management information difference data 11. Accordingly, even if the power supply is abnormally shut off, when the power supply is started next, the management information can be recovered to the latest management information before the abnormal power supply shut-off occurs.

Further, in the second embodiment, the second non-volatile memory 6B which stores the management information difference data 11 is assembled in the memory controller 7B. With the configuration, the memory system 1B that has an area smaller than the memory system 1A according to the first embodiment can be manufactured. Further, since according wiring for connecting the second non-volatile memory 6B to the memory controller 7B is shortened, the memory system 1B, which operates at high speed without noise, can be provided.

Note that it is needless to say that the invention is not limited only to the embodiments and may be variously modified within a scope which does not depart from the gist of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a volatile memory;
a first non-volatile memory connected to the volatile memory;
a second non-volatile memory connected to the volatile memory; and
a memory controller configured to store latest management information to the volatile memory, to store previous management information to the first non-volatile memory, and to store difference data between the latest management information and the previous management information to the second non-volatile memory.

2. The memory system according to claim 1, wherein the second non-volatile memory has a latency smaller than the first non-volatile memory and has a capacity smaller than the volatile memory.

3. The memory system according to claim 1, wherein the second non-volatile memory has the rewritable number of times larger than the first non-volatile memory.

4. The memory system according to claim 1, wherein the second non-volatile memory is assembled in the memory controller.

5. The memory system according to claim 1, wherein when an abnormal power supply shut-off occurs, the memory controller recovers the latest management information on the volatile memory based on the previous management information and the difference data.

6. The memory system according to claim 1, wherein when a power supply is normally shut-off, the memory controller writes the latest management information to the first non-volatile memory and erases the difference data.

7. The memory system according to claim 1, wherein the memory controller is configured to store a start code to an address just in front of the difference data and to store a distal end code to an address just behind the difference data in the second non-volatile memory.

8. The memory system according to claim 7, wherein when the difference data is overwritten, the memory controller is configured to store difference data, which is to be overwritten, from an address of the distal end code and to store a new distal end code, which is to be overwritten, on an address just behind the difference data.

9. The memory system according to claim 7, wherein when the difference data is erased, the memory controller is configured to store a new start code on an address of the distal end code and to store a new distal end code on an address just behind the new start code.

10. The memory system according to claim 7, wherein when the difference data is rewritten, the memory controller is configured to store a new start code on an address of the distal end code, to store a new difference data, which is to be rewritten, from an address just behind the new start code, and to store a new distal end code on an address just behind the new difference data.

11. The memory system according to claim 7, wherein when the difference data is read, the memory controller executes reading by sequentially increments an address from a leading end address of the second non-volatile memory, and when the start code is read before the distal end code is read, the memory controller reads data from an address just behind the start code up to an address just in front of the distal end code as the difference data.

12. The memory system according to claim 7, wherein when the difference data is read, the memory controller executes reading by sequentially increments an address from a leading end address of the second non-volatile memory, and when the distal end code is read before the start code is read, the memory controller reads the data from the leading end address up to an address just in front of the distal end code and the data from an address just behind the start code to an distal end address of the second non-volatile memory as management information difference data.

13. The memory system according to claim 7, wherein when the second non-volatile memory is filled with the difference data, the memory controller writes the latest management information to the first non-volatile memory and erases the difference data.

14. A data storage method of a memory system, the memory system including a memory controller, the method comprising:
storing latest management information to a volatile memory;
storing previous management information to a first non-volatile memory connected to the volatile memory; and
storing difference data between the latest management information and the previous management information to a second non-volatile memory connected to the volatile memory.

15. The data storage method according to claim 14, wherein the second non-volatile memory has a latency smaller than the first non-volatile memory and has a capacity smaller than the volatile memory.

16. The data storage method according to claim 14, wherein the second non-volatile memory has the rewritable number of times larger than the first non-volatile memory.

17. The data storage method according to claim 14, wherein the second non-volatile memory is assembled in the memory controller.

18. The data storage method according to claim 14, further comprising: when an abnormal power supply shut-off occurs, recovering the latest management information on the volatile memory based on the previous management information and the difference data.

19. The data storage method according to claim 14, further comprising: when a power supply is normally shut-off, writing the latest management information to the first non-volatile memory and erasing the difference data.

20. The data storage method according to claim 14, for the second non-volatile memory, further comprising:
storing a start code on an address just in front of the difference data; and
storing a distal end code on an address just behind the difference data.
